(19) United States
(12) Patent Application Publication
(10) Pub. No.: US 2019/0220846 A1
(43) Pub. Date: Jul. 18, 2019

(54) DIGITAL WALLET

(71) Applicant: Ali Asad PIRZADA, Hamilton (CA)

(72) Inventor: Ali Asad PIRZADA, Hamilton (CA)

(21) Appl. No.: 15/872,198

(22) Filed: Jan. 16, 2018

(51) Int. Cl. G06Q 20/34; G06Q 20/36

(52) U.S. Cl. CPC G06Q 20/341; G06Q 20/367

(57) ABSTRACT

Disclosed herein are digital wallets 100 comprising a body 102, a front screen 108, a back screen 302, and a pull-out card 402 having an electronic chip 404, wherein the front screen 108 and the back screen 302 display information regarding a plurality of cards, which information is stored on the digital wallet 100.

### FIELD OF THE INVENTION

The present invention is in the field of devices having digitally stored identification and/or credit card information.

### BACKGROUND OF THE DISCLOSURE

Nowadays people carry many plastic cards with them. These cards include credit cards from multiple banks, debit cards for multiple accounts, identification cards, such as driver licenses, or membership cards, such as fitness club memberships, frequent customer cards, and a score of others. As the result of these multiplicity of cards, wallets for both men and women have become large unwieldy collections of plastic that are uncomfortable to carry in one's pocket or purse. Recent attempts to digitize the use of credit cards have fallen short. For example, programs such as Apple Pay® and other similar smart phone-based technologies require specialized near field communication (NFC) readers for use with their products. Further, these devices also store information related to credit or debit cards. They are not useful for digitizing identification or membership cards. Accordingly, a need exists in the art to develop a system and/or device that can digitize the information on plastic cards in a practical way.

### SUMMARY OF THE INVENTION

Disclosed herein are digital wallets 100 comprising a body 102, a front screen 108, a back screen 302, and a pull-out card 402 having an electronic chip 404, wherein the front screen 108 and the back screen 302 display information regarding a plurality of cards, which information is stored on the digital wallet 100.

### BRIEF DESCRIPTION OF THE DRAWINGS

FIG. 1 illustrates the front face of an embodiment of the disclosed digital devices.

FIG. 2A provides a front view of a USB port of the disclosed digital devices.

FIG. 2B provides a front view of the pull-out card slot of the disclosed digital devices.

FIG. 3 illustrates the back of the disclosed digital devices.

FIG. 4 illustrates an embodiment of a pull-out card of the disclosed digital devices.

FIG. 5 illustrates an embodiment of a front screen that pivots to open the interior of the disclosed digital devices.

### DETAILED DESCRIPTION OF THE EMBODIMENTS

### Parts List

The following list of parts refers to the accompanying drawings:
100: An embodiment of the disclosed devices.
102: Housing for the disclosed devices.
104: Inner edge of the housing.
106: Outer edge of the housing.
108: The front screen of the device.
110: A plurality of buttons that control the function of the device.
112: Slot to retrieve the pull-out card.
114: Universal serial bus (USB) port.
302: The back screen of the device.
304: Camera.
306: Scanner.
402: Pull-out card.
404: Electronic chip on pull-out card.
502: Hinge on the front screen.
504: Interior pocket.

The present disclosure is directed to digital wallets. The wallets of the present disclosure comprise a body, a front screen, and a back screen. A user inputs the information on a plastic card, such as a credit card, identification card, membership card, and the like, into the device. Optionally, during use the front screen of the wallet displays the front face of the plastic card, while the back screen of the wallet displays the back face of the plastic card. In some embodiments, the digital wallet comprises a pull out card having an electronic chip, that allows the stored card to be used with a chip reader. In some embodiments, the electronic chip card complies with the EMV standard (Europay, MasterCard, Visa).

The information that is obtained from a card includes, but is not limited to: issuing bank or organization, card number, expiration date, card holder name, card security code, image of the card holder's signature, and the like.

Currently certain devices, such as smart phones, are configured to store information regarding a credit card. But these systems, such as Apple Pay®, do not allow for the two faces of the card to be visible. In addition, these systems can only be used with specialized NFC devices. Consequently, the advantages of the presently disclosed digital wallets are numerous. A user can see and/or display both faces of a stored card. The stored card can be any card and not just a credit card. For example, fitness club membership cards, frequent shopper cards, frequent flier cards, health insurance cards, driver licenses, library cards, and any other type of plastic card in use. The pull out card allows for the stored card to be used with a chip reader, a feature that is not compatible with the currently used systems.

Throughout the present disclosure, reference is made to “front” and “back” of either a plastic card or the presently disclosed digital wallets. By “front of a card,” or similar language, it is meant the face of the card that displays the most information about the identity of the cardholder. By “front of the device,” or similar language, it is meant the face of the device that features the screen that displays the front face of the card. The “back” side is, naturally, the opposite of the “front” in both cases.

The further features and advantages of the digital wallets disclosed herewith are now discussed with reference to the accompanying drawings, in which like numbers refer to like features.

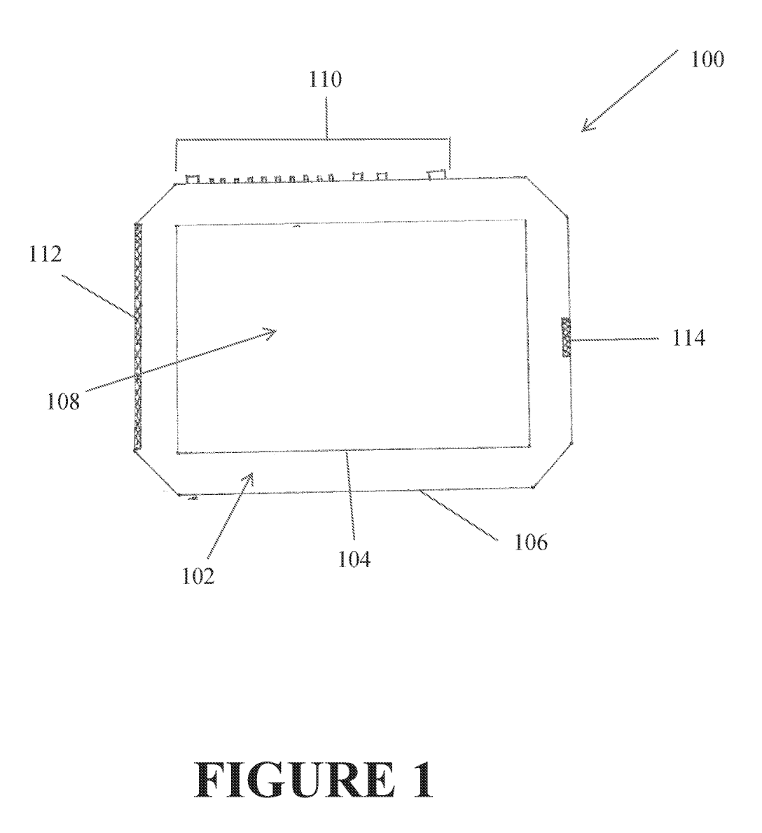

FIG. 1 illustrates the front face of an embodiment of the disclosed digital devices 100. The device 100 comprises a housing 102, or a casing. The housing 102 comprises an inner edge 104 and an outer edge 106. In some embodiments, the inner edge 104 defines the borders of a front screen 108, described further below.

In some embodiments, the housing 102 is of a generally rectangular shape. By the device being of a shape “generally,” it is meant that the housing comprises a shape that is closest to the stated geometrical shape. For example, by a “generally rectangular shape” it is meant that the device comprises 4 sides and each side makes an angle with its adjoining sides that are about 90°. In some embodiments, the corners of the housing 102 are at right angles. In other embodiments, for example those shown in the accompanying drawings, the corners of the housing 102 are tapered. In some embodiments, the tapered corners are straight, such as the ones shown in the accompanying drawings, while in other embodiments, the tapered corners are curved.

In some embodiments, the housing 102 is of such a size that the device 100 comfortably fits in the user's pocket or purse. In some embodiments, the length of the housing 102 is between about 50-120 mm, or between about 70-100 mm, or between about 80-90 mm. In some embodiments, the width of the housing 102 is between about 30-80 mm, or between about 40-70 mm, or between about 50-60 mm. In some embodiments, the depth of the housing 102 is between about 5-40 mm, or between about 15-35 mm, or between about 20-30 mm. In some embodiments, the width of the space between the inner edge 104 and the outer edge 106 of the housing 102 is between about 1-30 mm, or between about 5-20 mm, or between about 8-15 mm.

Throughout the present disclosure the term “about” a certain value means that a range of value ±25%, preferably about ±10%, and more preferably a range of value ±5%, is contemplated. Thus, for example, having a length of about 10 mm includes the length being between 7.5 mm and 12.5 mm, and preferably between 9 mm and 11 mmv, and more preferably between 9.5 mm and 10.5 mm. Furthermore, when about a range is given, it is understood that the word “about” qualifies both termini of the range. Thus, for example “about 7-10” means “about 7 to about 10.”

In some embodiments, the device 100 further comprises a plurality of buttons 110. The buttons 110 control the function of the device 100. For example, one of the buttons 110 is a power button that turns the device 100 on or off. In some embodiments, there is a button 110 corresponding to a stored card. By pressing the specific button 110, its respective card is activated for use. Additional examples of functionality that can be managed by buttons 110 include, but are not limited to, activating the camera feature, adjusting the volume of the device 100's speakers, toggle between the various cards, and other like functions. In some embodiments, the control buttons for the listed functionalities are icons on the front screen 108 or back screen 302 (see below).

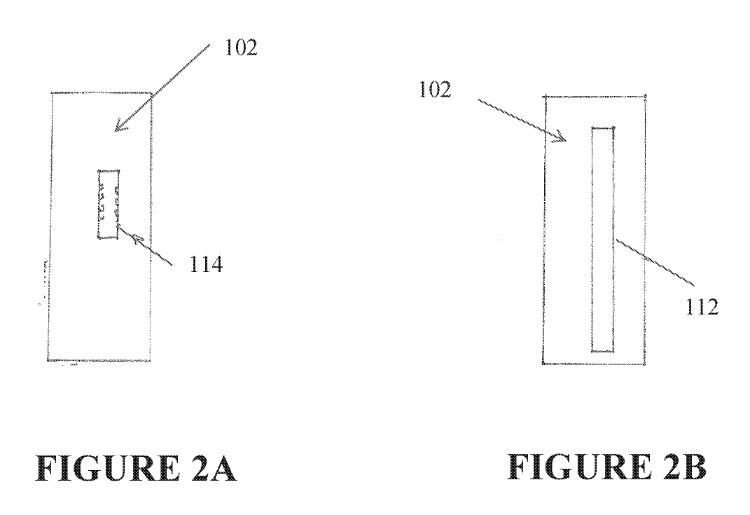

In certain embodiments, a universal serial bus (USB) port 114 is provided that allows the device 100 to communicate with other devices by wire. In some embodiments, the USB port 114 is a standard USB port, for example, Type A, Type B, Mini A, Mini B, Micro A, or Micro B, or any other type of USB ports now used or developed in the future. In some embodiments, the device 100 connects to a charger through the port 114. FIG. 2A provides a front view of the port 114.

In some embodiments, a slot 112 is provided through which a pull-out card 402 (see below) is retrieved. FIG. 2B provides a front view of the slot 112.

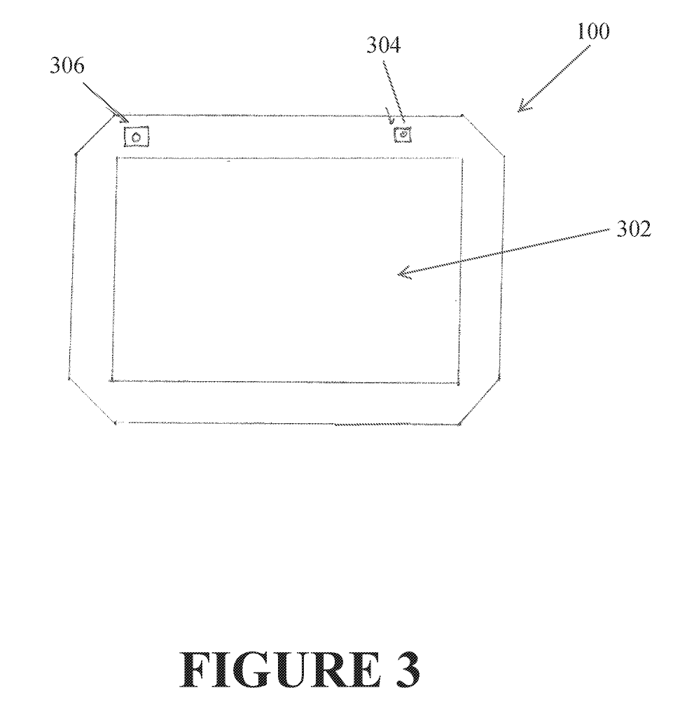

FIG. 3 illustrates the back of the device 100. In some embodiments, the device 100 comprises a back screen 302. In some embodiments, the screen 108,302 is each independently a liquid-crystal display (LCD) screen. In other embodiments, the screen 108,302 is a screen configured to display digital images. In some embodiments, the screen 108,302 is a touch screen display. In some embodiments (not shown), the device 100 comprises additional screens on the sides of the device. In certain of these embodiments, some of the icons related to the functionality of the device 100 are located on the side screens.

In some embodiments, the front screen 108 and the back screen 302 are of the same size. In other embodiments, the sizes of the two screens is different. In some embodiments, the screen 108,302 is smaller, in height and/or width, than the border defined by the inner edge 104. In some of these embodiments, another ribbon occupies the space between the edge of the screen 108,302 and the inner edge 104.

In some embodiments, the device 100 comprises a camera 304 located on the back of the device 100. The camera can be used to take pictures of the plastic cards for future display on the screen 108,302, or can be used to take pictures of interesting things one encounters, similar to any other camera or phone camera.

In some embodiments, a card scanner 306 is also provided. In these embodiments, the scanner 306 obtains the information regarding the plastic card, as opposed to the camera 304. The image obtained from the scanner 306 or the camera 304 is processed by an optical character recognition (OCR) that converts aspects of the image, such as the name on the card, the card number, expiration date, and the like, to digital data.

In some embodiments, the device 100 can be connected to an external device, such as a desktop or laptop computer, a memory stick, an external hard drive, a desktop scanner, or other similar device, through the USB port 114. The information regarding the plastic card of interest is then obtained through the external device. In these embodiments, the information is first uploaded onto the external device, either by scanning the card by a scanner attached to the external device, or the scanner itself, and then downloaded onto the device 100.

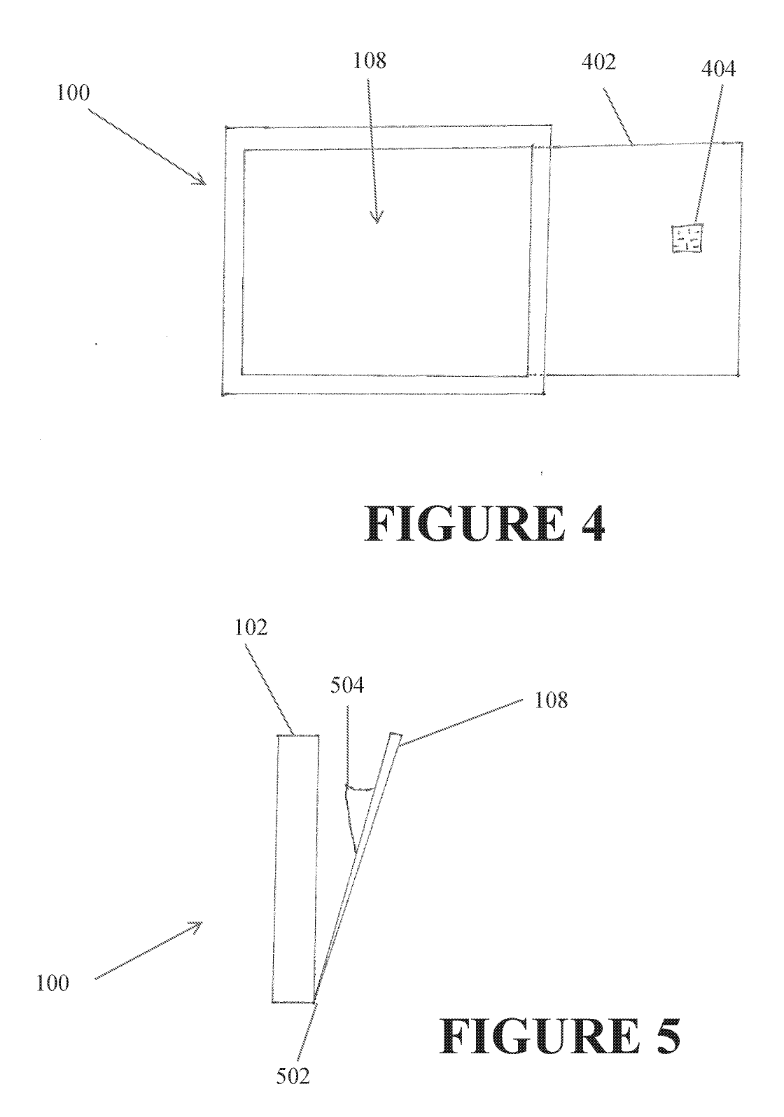

As illustrated in FIG. 4, in some embodiments, the device 100 comprises a pull-out card 402. The pull-out card 402 is of the same width and thickness as a regular credit card. An electronic chip 404 is located on the pull-out card 402. The chip 404 is of the same size and function as a chip on a regular credit card. The dimensions of a regular credit card currently is about 85.60 mm×53.98 mm (about 3.370 in×2.125 in). The thickness of a card is about 0.76 mm ( 1/32 in). The length of the pull-out card 402 is such that when the pull-out card 402 is inserted into a credit card chip reader, the chip 404 makes electronic contact with the chip reader and the chip reader reads the chip 404.

In some embodiments, the chip 404 is in electronic communication with a database in device 100 that contains all the stored cards' information. When a particular card is selected, the information regarding that card is sent to the chip 404 such that when the chip 404 is inserted into a chip reader, the information about the selected card is communicated with the chip reader.

In some embodiments, the front side of the device 100 at least partially separates from the body 102 of the device 100 to allow access to the interior of the device 100. In some embodiments, the front screen 108 separates from the rest of the device 100. In these embodiments, a friction lock, or other type of lock, holds the front screen 108 in place. In these embodiments, the front screen 108 snaps into place as a whole.

In other embodiments, such as the one shown in FIG. 5, the device 100 comprises a hinge 502 at one side such that the front screen 108 pivots about the hinge and provides access to the interior of the device 100. In some embodiments, the hinge 502 is at the bottom of the screen 108. In other embodiments, the hinge 502 is at the top or to the sides. In some embodiments, the interior of the device 100 comprises a pocket 504. In some embodiments, the pocket 504 is of such size that can accommodate a number of bills, such as dollar bills, or other items, such as keys.

1. A digital wallet 100 comprising a body 102, a front screen 108, a back screen 302, and a pull-out card 402 having an electronic chip 404, wherein the front screen 108 and the back screen 302 display information regarding a plurality of cards, which information is stored on the digital wallet 100.

2. The digital wallet of claim 1, wherein the housing 102 comprises an inner edge 104 and an outer edge 106, wherein, the inner edge 104 defines the borders of a front screen 108.

3. The digital wallet of claim 1, further comprising a camera 304 and a card scanner 306.

4. The digital wallet of claim 1, wherein the front screen 108 and the back screen 302 is each independently a touch screen display.

5. The digital wallet of claim 1, further comprising a plurality of buttons 110, which control one or more function of the device 100.

6. The digital wallet of claim 1, wherein the front screen 108 or the back screen 302 features electronic icons, which control one or more function of the device 100.

7. The digital wallet of claim 5, wherein the one or more function is selected from turning the digital wallet 100 on or off, choosing the card to display, activating a camera feature, activating a scanning feature, adjusting volume of a speaker, toggle between the plurality of cards.

8. The digital wallet of claim 1, further comprising a universal serial bus (USB) port 114.

9. The digital wallet of claim 1, wherein the USB port 114 is a standard USB port, selected from Type A, Type B, Mini A, Mini B, Micro A, or Micro B USB port.

10. The digital wallet of claim 1, further comprising a slot 112 through which the pull-out card 402 is retrieved.

11. The digital wallet of claim 1, wherein the pull-out card 402 is of the same width and thickness as a regular credit card.

12. The digital wallet of claim 1, further comprising a hinge 502 at one side such that the front screen 108 pivots about the hinge and provides access to the interior of the device 100.

13. The digital wallet of claim 1, wherein the interior of the device 100 comprises a pocket 504.

14. The digital wallet of claim 6, wherein the one or more function is selected from turning the digital wallet 100 on or off, choosing the card to display, activating a camera feature, activating a scanning feature, adjusting volume of a speaker, toggle between the plurality of cards.
